(19) United States
(12) Patent Application Publication
(10) Pub. No.: US 2026/0341607 A1
(43) Pub. Date: Oct. 29, 2026

(54) SWITCHGEAR PLATE

(71) Applicant: EATON INTELLIGENT POWER LIMITED, Dublin 4 (IE)

(72) Inventors: Bernd SPRITZENDORFER, Urschendorf (AT); Dominik DORNHACKL, Schrems (AT); Michael ERTL, Hirschbach (AT); Thomas JANSENBERGER, Wien (AT)

(21) Appl. No.: 19/491,054

(22) PCT Filed: Jun. 23, 2024
(86) PCT No.: PCT/EP2024/067574

§ 371 Date: Dec. 8, 2025

(30) Foreign Application Priority Data
Jun. 29, 2023 (GB) 2309863.5

(51) Int. Cl. H01H 9/34; H01H 73/18

(52) U.S. Cl. CPC H01H 9/346; H01H 9/345; H01H 73/18; H01H 2009/348

(57) ABSTRACT

Some embodiments relate to a switchgear including a first contact and a second contact configured to form an electrical conducting path through the switchgear. The second contact can be moved relative to the first contact. The switchgear can include a first arc runner electrically connected to the first contact, a second arc runner electrically connected to the second contact when the first contact and the second contact are separated, an arc extinguishing chamber arranged at least partially in a space between the first arc runner and the second arc runner, an arc guiding plate having a first surface and a second surface opposite to the first surface, wherein the arc guiding plate is formed in a single piece from a non-conductive material, a pre-chamber area disposed between the arc extinguishing chamber and the first and second contacts.

### CROSS-REFERENCE TO RELATED APPLICATIONS

This application is a national phase filing under 35 C.F.R. § 371 of and claims priority to PCT Patent Application No. PCT/EP2024/067574, filed on Jun. 23, 2024, which claims priority to European Patent Application No. 2309863.5, filed on Jun. 29, 2023, the contents of which are hereby incorporated in their entireties by reference.

### FIELD OF THE DISCLOSURE

This relates to protecting a switchgear from electrical arcs. In particular, this relates to an arc guiding plate for protecting a switchgear.

### BACKGROUND OF THE DISCLOSURE

Electrical circuits may be damaged by larger than normal currents flowing through the circuit (due to, for example, short circuits or overloads). One approach to prevent damage to an electrical circuit is to use a switchgear to interrupt the flow of large currents by separating electrical contacts within the circuit (i.e. by opening the circuit). For example, an MCB (miniature circuit breaker) of the switchgear protects the current line in case of an overload or short circuit by interrupting the faulty circuit and thus reducing the otherwise negative impact of the thermal stress from large currents on the e.g., switchgears plastic insulation, and the components/circuit environment. In case of a short-circuit, the increasing current on the line triggers a magnetic operated actuator, which interacts with the MCB's mechanism to open the electrical contacts. Any suitable circuit breaker can be used.

Separating electrical contacts carrying a large electric current cause an electric arc to form between the contacts. Opening of electrical contacts under load (high current & voltage) is always associated with the generation of an electric arc (between the separating contacts). The arc originates from an initial rupture of a small liquid metal “bridge” between the opening contacts (formed due to local overheating of the contact material when the current density increases as the cross-section of the contact area goes to zero when the contacts open). As gas passes through the rupture, it is ionized, generating a plasma. In other words, the arc between the two contacts is a plasma state (up to 10K in temperature).

The plasma can cause damage to, and contamination of, components in the switchgear. For example, the high temperatures when an arc is formed or generated may melt portions of the contacts, and the contact surface is further degraded or eroded by the arc itself the longer the arc is sustained. In addition to damage to the contact, the melted material may be transferred to other components of the switchgear. System contamination and damage can reduce the minimum dielectric strength of the switchgear, which can make it easier for arcs to form and could lead to a flashover (even when the contacts are separate). Therefore, the arc has to move away from the contact area to avoid degradation of the contact's surface (due to erosion by the arc) and other damage to the circuit breaker.

To increase safety and durability, switchgears typically comprise an arc extinguishing chamber. Switchgears are configured to drive the ionised gas, e.g. the plasma/electrical arc, towards the arc extinguishing chamber. Various arc extinguishing methods can be used within the chamber, as required by the specific application. In order to drive the arc towards the arc extinguishing chamber, the current path within the circuit breaker (for example, the MCB) of the switchgear can be designed to establish a current loop, with the arc being part of the loop. Magnetic forces (Lorentz force) created by the current loop and acting on the arc will move/drive the arc away from the contacts. In particular, arc runners are used to take over the arc foot-points from the fixed and movable contacts, respectively, and lead the arc away from the contacts towards the arc extinguishing chamber.

Once the arc is formed the current continues to rise, increasing the energy of the arc and thereby increasing the plasma pressure. Therefore, in addition to the magnetic or Lorentz forces driving the arc, the movement of the arc is affected by gas dynamics within the switchgear (i.e. by the interaction between the plasma and other gases). The heat transferred to the surroundings by the electric arc increases the temperature and thus the pressure of the gases within the switchgear. In particular, the high-pressure gas created by the high temperature at the point of formation of the arc leads to a shockwave travelling (with speed of sound) in both directions from the point of arc generation. Reflections due to surfaces or obstacles in the switchgear (e.g. narrowing due to the arc extinguishing chamber components) can direct this shockwave back to the moving arc column and retard its movement to the arc extinguishing chamber.

In other words, these high-pressure gases can act to slow the arc down on its way to the arc extinguishing chamber, unless they are removed. AU676934B2 discloses apertures which allow these gases to flow away from the area, reducing the gas pressure in the vicinity of the front of the arc. However, the generated gases can also be used to drive the arc away from the opening contacts and towards the arc extinguishing chamber. For example, DE 102017204942 A1 discloses a switchgear configured to route the high-pressure gases generated behind the arc, increasing pressure behind the arc so as to help drive the arc towards the arc extinguishing chamber.

It is desirable to provide an improved switchgear which quickly extinguishes arcs and reduces system contamination.

### SUMMARY OF THE DISCLOSURE

A switchgear is provided as defined in the appended independent claim 1, with optional features defined in the dependent claims appended thereto.

In the following specification, a switchgear for protecting an electrical circuit is described. Two different embodiments of an arc guiding plate are described for use with the switchgear, or with any other suitable device.

### First Embodiment

According to a first embodiment of the disclosure, the switchgear comprises a first contact and a second contact which form an electrical conducting path through the switchgear. The second contact can be moved relative to the first contact. The switchgear further comprises: a first arc runner electrically connected to the first contact, a second arc runner which is electrically connected to the second contact when the first contact and the second contact are separated, an arc extinguishing chamber arranged at least partially in a space between the first arc runner and the second arc runner, and an arc guiding plate. The arc guiding plate comprises a first surface and a second surface opposite to the first surface. The arc guiding plate is formed in a single piece from a non-conductive material. The switchgear further comprises a pre-chamber area disposed between the arc extinguishing chamber and the first and second contacts and which is at least partially defined by the first and second arc runners and the first surface of the arc guiding plate. The first arc runner and the second arc runner are at least partially disposed on the first surface of the arc guiding plate. The first surface of the arc guiding plate comprises a channel having a first end and a second end, and the first and second ends of the channel are open.

Also disclosed herein is an arc guiding plate comprising a first surface and a second surface opposite to the first surface. The arc guiding plate is formed in a single piece from a non-conductive material. The first surface of the arc guiding plate comprises a channel having a first end and a second end, and the first and second ends of the channel are open. Optionally, the second surface of the arc guiding plate does not comprise a channel. Optionally, the second surface of the arc guiding plate may be flat (may comprise no protrusions).

Previous switchgears comprise, for example, a plurality of guide ribs partially disposed in a plurality of depressions or indentations (closed channels) formed in an arc guiding plate. The guide ribs channel or route the high-pressure gases generated by the arc behind the arc, so as to help drive the arc towards the arc extinguishing chamber. However, high-pressure and high-temperature gases can remain in the pre-chamber area after the arc has been extinguished, which can cause continued contamination and damage to the pre-chamber area or region. For example, the interaction of the high temperature arc with the non-conductive material of the arc guiding plate could enrich the gasses with carbon and derivatives thereof, which could deposit on internal parts of the switchgear after current interruption and cooling down of the gasses. Similarly, metal materials removed/sublimed from the contact material or the arc runners by the arc can be deposited when the gas cools. In other words, contaminants can be deposited on all surfaces of the switchgear. This contamination will negatively impact the dielectric properties of the breaker (a flash-over could occur afterwards, even if the contacts are separated). By using an arc guiding plate in accordance with the switchgear of the first embodiment, a switchgear with improved safety and robustness can be provided which reduces these problems of contamination.

In particular, the open channel may route some gases generated by the arc out of the pre-chamber area and towards the arc extinguishing chamber and other regions of the switchgear, thereby preventing the high-pressure gases from slowing down the arc or reducing this effect. In other words, the high-pressure gases may flow out of the channel, and thus out of the pre-chamber area, through the (open) first and second ends. In this way, the flow of high-pressure gases out of the pre-chamber area may be increased/improved; thereby, contamination of the pre-chamber area (and the switchgear more generally) as a result of the high temperatures and subsequent deposition of contaminants may be reduced whilst also effectively preventing the slowing down of the arc as it moves towards to the arc extinguishing chamber by the high-pressure gases.

However, these high-pressure gases may be reflected back into the pre-chamber area by components in the switchgear, and these reflections can retard arc movement. The open channel may therefore also route the gases which are reflected back into the pre-chamber area around the arc and out of the prechamber area. In other words, the backflow of gases may flow into and out of the channel through the (open) first and second ends. In this way, the backflow of gases out of the pre-chamber area may be improved and contamination of the pre-chamber area may thereby be reduced. As such, a switchgear which rapidly extinguishes arcs and reduces system contamination may be provided. A safer and more robust switchgear may thus be provided.

By forming the arc guiding plate in a single piece, the manufacturing process of the arc guiding plate may be simplified. By forming the arc guiding plate from a non-conductive material, the risk of electrical and thermal damage to the arc guiding plate caused by the electrical arc may be reduced. In some implementations, the arc guiding plate is formed from a material configured to help de-energize the arc. For example, dedicated plate materials could support to de-energize the arc, as a small fraction of the plate material could vaporize, reducing the arc energy (cooling) by the evaporation energy of the material. Optionally, the material is a plastic or a ceramic.

Optionally, the arc guiding plate is a first arc guiding plate and the switchgear further comprises a second arc guiding plate, and the first arc runner and the second arc runner are at least partially disposed between the first arc guiding plate and the second arc guiding plate to form the pre-chamber area. By forming the pre-chamber area with a first and second arc guiding plate as discussed herein, the arc taken for the arc to be extinguished may be reduced and the backflow of gases out of the pre-chamber area may be improved.

Optionally, the second arc guiding plate is identical to the first arc guiding plate, and the first surface of the first arc guiding plate and the second surface of the second arc guiding plate form the pre-chamber area. This arrangement may reduce the cost and time of manufacturing the pre-chamber area, as the same mould can be used to form both the first and second arc guiding plates.

Optionally, the second surface of the arc guiding plate does not comprise a channel. The second surface of the arc guiding plate may be flat in some specific embodiments. In other words, the flat second surface may comprise no protrusions. This arrangement may further simplify the manufacturing process of the arc guiding plate and increase the robustness of the arc guiding plate.

Optionally, the arc guiding plate comprises a first edge facing towards the arc extinguishing chamber. The first end of the channel meets the first edge of the arc guiding plate. By having the first open end facing towards the arc extinguishing chamber, the backflow of gases reflected back into the pre-chamber area by the arc extinguishing chamber may more easily flow into the open channel and out of the pre-chamber area, thereby helping with reducing contamination of the pre-chamber area.

Optionally, the arc guiding plate comprises a second edge facing towards a region of the switchgear in which the first and second contacts are at least partially disposed. The second end of the channel meets the second edge of the arc guiding plate. By directing the flow of gases towards this region in a quick and efficient manner, contamination of the switchgear may be reduced, as discussed in more detail below, whilst also helping to improve the backflow of gases out of the pre-chamber area.

Optionally, a position at which the second end of the channel meets the second edge of the arc guiding plate is aligned with a first gap formed between the first and second contacts when the first and second contacts are separated. This arrangement may reduce contamination of the first and second contacts by expelling gases (and thus sublimated metals and other contaminants) away from the surface of the first and second contacts.

Optionally, the channel comprises a first, second, and third straight portion and a first and second curved portion. The first curved portion connects the first and second straight portions and the second curved portion connects the second and third straight portions. This arrangement may increase the effective length of the channel such that the backflow of gases out of the pre-chamber area may be increased. As such, contamination of the pre-chamber area may be reduced and the arc may move towards the arc extinguishing chamber more quickly.

Optionally, the first arc runner does not overlap the channel when the switchgear is viewed in a direction perpendicular to the first surface of the arc guiding plate. This arrangement may prevent or reduce obstruction of the high-pressure gases flowing into the channel (by the arc runner). As such, the flow of gases out of the pre-chamber area may be improved.

Optionally, the arc guiding plate comprises a third edge facing towards the second arc runner and the channel does not meet the third edge of the arc guiding plate. This arrangement may concentrate the flow of gases along the channel towards the region of the switchgear comprising the first and second contacts, thereby helping to reduce contamination of the first and second contacts.

Optionally, there is a second gap between at least a portion of the third edge of the arc guiding plate and the second arc runner when the switchgear is viewed in the direction perpendicular to the first surface of the arc guiding plate. This may provide an additional outlet for the high-pressure gases in the pre-chamber area. The outlet can improve the backflow of gases out of the pre-chamber area and thereby can reduce the pressure in front of the arc, facilitating the movement of the arc towards the arc extinguishing chamber.

Optionally, the third edge of the arc guiding plate comprises a tapered portion. The tapered portion may act as an additional channel for the high-pressure gases. This arrangement may further improve the flow of gases out of the pre-chamber area, thereby helping with facilitating the movement of the arc towards the (arc extinguishing) chamber, in the manner discussed above.

Optionally, the second arc runner is at least partially disposed on the tapered portion of the third edge. As the tapered portion may act as an additional channel, the high-pressure gases generated by the arc may be routed away from the arc base point (arc foot-point) on the second arc runner. This arrangement may increase the speed at which the arc base point moves towards the chamber, as it may not be hindered by the high-pressure gases generated by the arc formation.

Optionally, the first and second surfaces of the arc guiding plate comprise one or more through holes. The through holes may provide a means of fastening the arc guiding plate in place to increase the stability of the arc guiding plate. The one or more through holes may also ventilate gas from within the pre-chamber area to other regions of the switchgear. This arrangement may further improve flow of gases out of the pre-chamber area, reducing the pressure in front of the moving arc and facilitating movement of the arc towards the arc extinguishing chamber.

Optionally, the arc guiding plate is made of a plastic material. The use of a plastic material may also reduce the cost of manufacturing the arc guiding plate. Moreover, the use of plastic can help reduce the arc energy; for example, a small fraction of the plastic material could vaporize, reducing the arc energy (cooling) by the evaporation energy of the plastic material.

### Second Embodiment

According to a second embodiment of the disclosure, there is provided a switchgear for protecting an electrical circuit. The switchgear comprises a first contact and a second contact which form an electrical conducting path through the switchgear. The second contact can be moved relative to the first contact. The switchgear further comprises: a first arc runner electrically connected to the first contact, a second arc runner which is electrically connected to the second contact when the first contact and the second contact are separated, an arc extinguishing chamber arranged at least partially in a space between the first arc runner and the second arc runner, and an arc guiding plate. The arc guiding plate comprises a first surface, a second surface opposite to the first surface and a first edge facing towards a first portion of the second arc runner. The first edge and the first portion are not parallel to one another. The switchgear further comprises a pre-chamber area disposed between the arc extinguishing chamber and the first and second contacts and which is at least partially defined by the first and second arc runners and the first surface of the arc guiding plate. The first arc runner and the second arc runner are at least partially disposed on the first surface of the arc guiding plate. The first arc runner has a shorter length than the second arc runner.

Previous switchgears comprise arc guiding plates configured to fill a region extending between the first and second contacts, the first and second arc runners, and the arc extinguishing chamber (pre-chamber area). However, the high-pressure gases can build up within the pre-chamber area, and can remain in this region after the arc has been extinguished, which can cause continued contamination and damage to the pre-chamber area (or region). For example, the interaction of the high temperature arc with any non-conductive material of the arc guiding plate could enrich the gasses with carbon and derivatives thereof, which could deposit on internal parts of the switchgear after current interruption and cooling down of the gasses. Similarly, metal materials removed/sublimed from the contact material or the arc runners by the arc can be deposited when the gas cools. In other words, contaminants can be deposited on all surfaces of the switchgear. This contamination will negatively impact the dielectric properties of the breaker (a flash-over could occur afterwards, even if the contacts are separated). By using an arc guiding plate in accordance with the switchgear of the second embodiment, a switchgear with improved safety and robustness can be provided which reduces these problems of contamination.

Optionally, the first edge is a straight edge. In particular, the straight edge of the arc guiding plate reduces the surface area of the arc guiding plate, such that it does not fill the entire region between the first and second contacts, first and second arc runners and arc extinguishing chamber. In this way, the pressure in the pre-chamber area may be reduced (by reducing the wall surface area of the pre-chamber area). The retarding effect of the gas on the arc movement may therefore be reduced.

Typical arc guiding plates, including the arc guiding plate described herein, are configured such that the first arc runner has a shorter length than the second arc runner. The arc base point (foot-point) formed on the second contact, which travels along the second arc runner as the arc moves, therefore takes longer to arrive at the arc quenching chamber than an arc base point (foot-point) formed on the first contact, which travels along the first arc runner as the arc moves. This results in a time-shifted entry of the arc base points into the arc guiding chamber.

By using an arc guiding plate in accordance with the switchgear of the second embodiment, a switchgear with improved arc extinguishing ability may be provided. In particular, as the arc guiding plate comprises a first edge, optionally a straight edge, facing towards a first portion of the second arc runner, the second arc runner is only partially disposed on the first surface of the arc guiding plate; in other words, there can be a gap between the first edge of the arc guiding plate and the first portion of the second arc runner when the switchgear is viewed perpendicular to the first surface of the arc guiding plate. The high-pressure gases can vent in the space between the first edge of the arc guiding plate and the second arc runner. The gap may provide an additional outlet for the high-pressure gases in the pre-chamber area, and thereby the flow of gases out of the pre-chamber area may be improved. As such, an arc base point travelling along the second arc runner is less exposed to the retarding effect of high-pressure gases in the pre-chamber. In this way, the slowing down of the arc base point on the second arc runner may be reduced, and the arc base points may enter the arc extinguishing chamber closer together in time. By improving the timed entry behaviour of the arc base points, the arc extinguishing capacity of the breaker may be improved.

Optionally, the first edge of the arc guiding plate is a first straight edge and the arc guiding plate further comprises a second straight edge facing towards the arc extinguishing chamber. Optionally, the first straight edge and the second straight edge are parallel to each other. This configuration may simplify manufacturing and improve alignment of the plate with the chamber.

Optionally, the first and second surfaces of the arc guiding plate do not comprise any grooves or channels. In other words, there are no indentations/recesses in the surface to provide channels. This configuration may improve the robustness of the arc guiding plate by avoiding any reduction in thickness of the plate.

Optionally, the first surface of the arc guiding plate and the second surface of the arc guiding plate are formed as separate pieces and assembled into an integrated structure. This arrangement may further improve the robustness of the arc guiding plate. In other examples, the first and/or second surfaces may comprise one or more grooves or channels.

Optionally, the first and second surface of the arc guiding plate are made of an insulating material. The insulating material may be a plastic material. This choice of material may reduce the risk of electrical and thermal damage caused by the electric arc. The use of a plastic, or other dedicated plate material, could also support to de-energize the arc, as a small fraction of the plastic material could vaporize, reducing the arc energy (cooling) by the evaporation energy of the plastic material.

Optionally, a metal plate is disposed between the first and second surfaces of the arc guiding plate. The first and second surface of the arc guiding plate may be configured to completely surround the metal plate. Metal parts, placed within the plastic plates, can help to further improve the arc movement due to its amplification of the magnetic forces (Lorentz force) acting to drive the arc towards the (arc extinguishing) chamber.

The configuration of the second embodiment may therefore improve the arc extinguishing capacity of the arc guiding plate. This may be particularly advantageous for circuit breakers with high currents/loads.

Optionally, the arc guiding plate is configured such that the distance between the arc guiding plate and the second arc runner is larger than the distance between the arc guiding plate and the first arc runner. This arrangement may reduce the slowing down of the arc base point travelling along the second arc runner by reducing the supply of high-pressure gas directed towards the arc base point on the second arc runner.

Optionally, the first arc runner at least partially overlaps the arc guiding plate when the switchgear is viewed perpendicular to the first surface of the arc guiding plate. This arrangement may increase the supply of high-pressure gases towards the arc base point travelling along the first arc runner and thereby reduce its speed.

In these ways, the timed entry behaviour of the arc base points into the arc extinguishing chamber may be further improved.

Optionally, the first surface of the arc guiding plate comprises a central protrusion. This may increase the thickness of at least a portion of the arc guiding plate, and thereby the robustness of the arc guiding plate may be improved.

Optionally, the central protrusion on the first surface of the arc guiding plate is a first central protrusion and the second surface of the arc guiding plate comprises a second central protrusion. The second central protrusion may be configured to be symmetric to the first central protrusion. This configuration may further improve the robustness of the arc guiding plate by increasing a thickness without impacting the overall footprint of the plate and arc runners. Optionally, in other examples, the second surface of the arc guiding plate is flat. This arrangement may simplify the manufacturing process of the arc guiding plate.

Optionally, the first and second arc runner do not overlap the central protrusion on the first surface of the arc guiding plate when the switchgear is viewed perpendicular to the first surface of the arc guiding plate.

Optionally, a second portion of the second arc runner is disposed on the first surface of the arc guiding plate between the central protrusion and a curved edge of the arc guiding plate. Optionally, the second portion of the second arc runner is disposed between the first portion of the second arc runner and the arc extinguishing chamber. A curved edge of the arc guiding plate proximate the second portion of the second arc runner may guide backflow of gases through the pre-chamber area, such that the stagnation pressure in this area of the plate is reduced. Moreover, the region between the central protrusion and the second portion of the second arc runner may act as a channel. This region may route high pressure gases generated by the arc and the backflow of gases out the pre-chamber area. In this way, movement of the arc towards the arc extinguishing chamber is not hindered by high pressure gases in the pre-chamber area. This may further improve the timed entry behaviour of the first and second arc base points into the arc extinguishing chamber. This configuration can be advantageous for high loads, as an effective channel may be formed on the first surface of the arc guiding plate without affecting the robustness of the arc guiding plate by reducing the thickness of the plate.

Optionally, the first and second surface of the arc guiding plate and the metal plate each comprise at least one through hole. The at least one through holes are aligned. This arrangement may provide a means of securing the arc guiding plate within the switchgear and may thereby increase the stability of the arc guiding plate.

Optionally, the arc guiding plate is a first arc guiding plate and the switchgear further comprises a second arc guiding plate. The first arc runner and the second arc runner may be at least partially disposed between the first surface of the first arc guiding plate and the second surface of the second arc guiding plate to form the pre-chamber area. In this way, a more robust pre-chamber area may be provided.

### BRIEF DESCRIPTION OF THE DRAWINGS

FIG. 1 illustrates a cross sectional view of the switchgear comprising an arc guiding plate according to the first embodiment.

FIG. 2 illustrates an example of the pre-chamber area of the switchgear comprising two identical arc guiding plates according to the first embodiment.

FIG. 3 illustrates another example of the pre-chamber area of the switchgear comprising two symmetric arc guiding plates according to the first embodiment.

FIG. 4 illustrates a cross sectional view of the switchgear comprising an arc guiding plate according to the second embodiment.

FIG. 5 illustrates an exploded view of the arc guiding plate according to a second embodiment.

### DETAILED DESCRIPTION

Embodiments of the present disclosure will now be described more fully hereinafter with reference to the accompanying drawings, in which embodiments of the present disclosure are shown. The same reference numbers indicate the same components throughout the specification.

This disclosure may, however, be embodied in different forms and should not be construed as limited to the embodiments set forth herein. Rather, these embodiments are provided so that this disclosure will be thorough and complete, and will fully convey the scope of the present disclosure to those skilled in the art.

It will be understood that when components are described as being “electrically connected” to each other, this refers to an electric current being able to flow between the components. This may be by means of direct or indirect physical contact (e.g., the components are soldered together, or joined with electrically conductive adhesive or paste, for example) or a proximate arrangement of the components such that an arc may be easily generated between the components to conduct a current.

It will be understood that, although the terms “first”, “second,” etc. may be used herein to describe various elements, these elements should not be limited by these terms. These terms are labels, and are only used to distinguish one element from another element. For instance, a first element discussed below could be termed a second element without departing from the teachings of the present disclosure. Similarly, the second element could also be termed the first element.

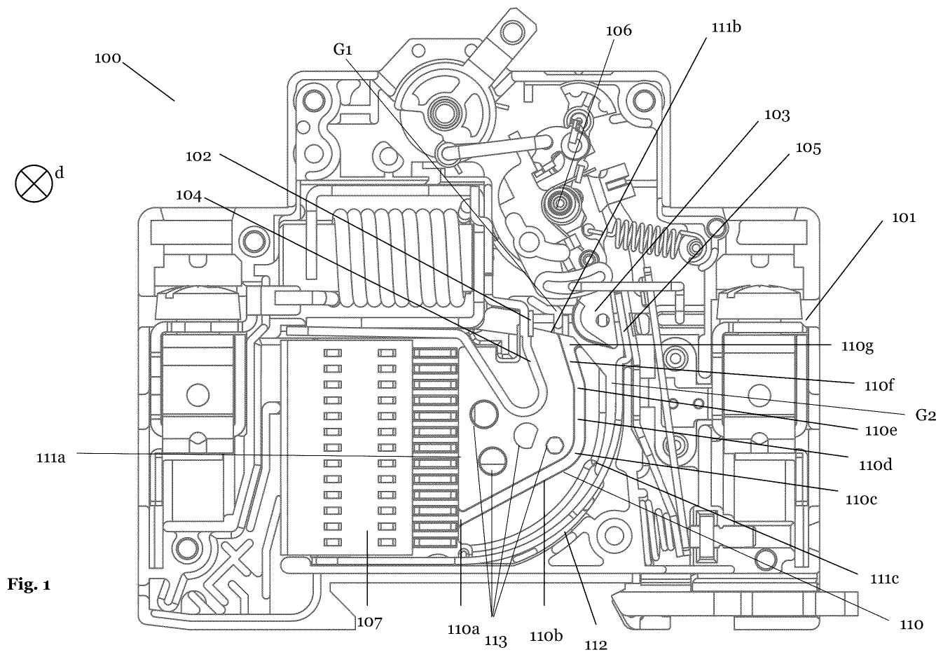

With reference to FIGS. 1 to 3, a switchgear 100 comprising a first embodiment of an arc guiding plate 109 for protecting an electrical circuit is described.

The individual components of the switchgear 100 described herein may be enclosed in a housing 101. The switchgear 100 comprises a first contact 102 and a second contact 103 which are electrically connected to an electrical circuit. The first and second contacts (102, 103) form an electrical conducting path through the switchgear 100. The first contact 102 is arranged such that it is stationary within the housing 101. The second contact 103 is arranged such that it can be moved relative to the first contact 102 within the housing 101. The second contact 103 is configured to be moved such that it is either electrically connected to the first contact 102 and enables current to flow, or is separated from the first contact 102 and interrupts the flow of current.

The switchgear 100 comprises an actuating element 106 connected to the second contact 103. The actuating element 106 is in these specific examples configured together with an electromechanical relay device to move the second contact 103, such that it is separated from the first contact 102 when a higher than normal current (that is, a current higher than a maximum current for which the switchgear was designed and tested to work reliably) flows through the electrical circuit. It will be understood that any suitable actuating element may be used.

When the first and second contacts (102, 103) are separated due to a high current in the electrical circuit, an arc is formed between the first and second contacts (102, 103). A first and second arc base point is formed on the first and second contacts (102, 103), respectively, and the air is ionised so that it becomes electrically conducting; the arc is formed in the air between the first and second contacts (102, 103), as discussed above.

The switchgear 100 further comprises a first arc runner 104 and a second arc runner 105 which are electrically connected to the first and second contacts (102, 103), respectively. The first arc runner 104 has a shorter length than the second arc runner 105. As such, the second arc base point takes a longer time to reach an arc extinguishing chamber 107 than the first arc base point (because the second arc runner 105 is longer). However, the first and second arc runners (104, 105) may have the same length, or the second arc runner 105 may have a shorter length than the first arc runner 104.

The first and second arc runners (104, 105) extend between the first and second contacts (102, 103), respectively, and an arc extinguishing chamber 107. Magnetic forces (Lorentz force) created by the high current act on the arc and drive the arc away from the separated first and second contacts (102, 103) and along the first and second arc runners (104, 105) towards the arc extinguishing chamber 107.

The arc extinguishing chamber 107 is a device configured to extinguish the arc when it enters the arc extinguishing chamber 107. In the illustrated embodiment, the arc extinguishing chamber 107 comprises a plurality of conducting rods/plates arranged parallel to and spaced apart from each other. When the arc strikes the conducting rods or stack of equally spaced metal rods/plates (the “splitter plates”), it is divided into a corresponding plurality of partial arcs which are electrically connected in series (the single arc is divided into many sub-arcs). In other words, the additional arc base points are created on all of the conducting rods/plates within the arc extinguishing chamber. By this means, the so-called “arc voltage” increases dramatically and acts against the driving voltage from the grid (e.g. 230 V). As soon as the arc voltage is higher than the grid voltage the arc will get extinguished and the current through the line is zero. The arc voltage is increased such that the current is insufficient to maintain the arc and the arc is extinguished. This happens within approximately 5-8 msec after the initial contact opening (termed “current limiting interruption”). However, alternative arc extinguishing chambers which employ a different mechanism to extinguish the arc, which are well known in the state of the art, may be used instead of or as well as. In other words, any suitable arc extinguishing approach may be used.

The switchgear 100 further comprises an arc guiding plate 109 disposed in a region in front of the arc extinguishing chamber 107. The shape of the arc guiding plate 109 is configured such that it generally extends between the first and second contacts (102, 103) and the arc extinguishing chamber 107. However, the shape of the arc guiding plate 109 is not limited thereto.

The arc guiding plate 109 comprises a first surface 109a and a second surface 109b opposite to the first surface 109a. The arc guiding plate 109 is formed as a single piece, which may simplify the manufacturing process of the arc guiding plate. The arc guiding plate 109 is formed from a non-conductive material, which may reduce the risk of electrical and thermal damage to the arc guiding plate 109 caused by the arc.

The first and second arc runners (104, 105) are partially disposed on the first surface 109a of the arc guiding plate 109. The first and second arc runners (104, 105) may, however, be completely disposed on the first surface 109a of the arc guiding plate 109. The arc guiding plate 109 is configured, together with the first and second arc runners (104, 105), to guide the arc towards the arc extinguishing chamber 107 quickly. The first surface 109a of the arc guiding plate, the first arc runner 104 and the second arc runner 105 at least partially define a pre-chamber area 108.

The first surface 109a of the arc guiding plate 109 comprises a channel 110 with a first end 110a and a second end 110g. The first surface 109a may comprise one or more channels 110, each having a first end 110a and a second end 110g. The channel(s) are configured so that the high-pressure gases generated by the arc are routed out of the pre-chamber area 108. As such, the arc may not be slowed down by the high-pressure gases and may reach the arc extinguishing chamber 107 more quickly, reducing the length of time the arc is present in the switchgear.

When the arc is in the arc extinguishing chamber 107, the high-pressure gases formed by generation of the arc may be reflected by other components of the switchgear 100, such as the arc extinguishing chamber, back towards the pre-chamber area 108. The gases may then flow back into the one or more channel(s) 110 through the first and second channel ends (110a, 110g). The first and second ends (110a, 110g) are open. This may facilitate the backflow of the high-pressure gases into and out of the channel 110. In this way, the backflow of high-pressure gases out of the pre-chamber area 108 may be improved, and thereby contamination of the pre-chamber area 108 may be reduced and the arc movement toward the arc extinguishing chamber may not be hindered. In these examples only one channel 110 is shown, but additional channels may be provided in any suitable location on/in the first surface 109a of the plate.

In the specific examples shown here, the second surface 109b of the arc guiding plate 109 does not comprise a channel. The second surface 109b of the arc guiding plate 109 is flat. It will be understood that the term “flat” in this context refers to a surface which does not comprise any protrusions from the surface. In some examples, the flat surface may be completely smooth and not comprise any indentions or recesses, in addition to not having any protrusions. However, the second surface 109b of the arc guiding plate 109 is not limited thereto. For example, it will be understood that the second surface might not be flat. In some implementations, the first and second surfaces (109a, 109b) may each comprise one or more open channels 110.

Forming a channel 110 on the first surface 109a or second surface 109b of the arc guiding plate 109 creates a relatively thin region of the arc guiding plate 109 compared to a thickness of the rest of the arc guiding plate 109, which thin area may not be able to withstand the high-pressures which occur in the pre-chamber area 108 as robustly as the thicker regions of the arc guiding plate 109. Robustness has to be balanced with the effective channelling or removal of gases.

In some specific embodiments, such as those shown with reference to the exemplary Figures, the first surface 109a comprises a single channel 110 (i.e. there is only one channel 110 on/in the first surface 109a). By only forming one open channel 110 on the first surface 109a of the arc guiding plate 109, a more robust arc guiding plate 109 may therefore be provided. The manufacturing process of the arc guiding plate 109 may also be simplified in this way. In other words, the use of a single channel 110 facilitates removal of the high-pressure gases from the pre-chamber area 108, whilst improving the robustness of the plate 109 overall. Such a plate 109 may also be easier to manufacture.

The arc guiding plate 109 comprises a first edge 111a facing towards the arc extinguishing chamber 107. The first end 110a of the channel 110 meets the first edge 111a of the arc guiding plate 109. By having the first open end 110a facing towards the arc extinguishing chamber 107, the high-pressure gases reflected by the arc extinguishing chamber 107 may more easily flow back into the open channel 110 through the first end 110a and out of the pre-chamber area 108 through the second end 110g. The backflow of gases out of the pre-chamber area 108 may thereby be improved and contamination of the pre-chamber area 108 reduced.

The arc guiding plate 109 may comprise a second edge 111b facing towards a region of the switchgear 100 in which at least one component of the switchgear 100 is at least partially disposed. In the illustrated embodiment, the arc guiding plate 109 comprises a second edge 111b facing towards a region of the switchgear 100 in which the first and second contacts (102, 103) are disposed. The second end 110g of the channel 110 meets the second edge 111b of the arc guiding plate 109 at a position which is aligned with a first gap G1 formed between the first and second contacts (102, 103) when the first and second contacts (102, 103) are separated.

Some of the material of the components proximate to the first and second contacts (102, 103) may be melted/sublimed due to the high temperatures generated as a result of the arc's formation. Therefore, the gases in the region of the first and second contacts (102, 103) may be contaminated with melted/sublimed material from these components and the contacts (102, 103) themselves. When the switchgear 100 cools, this material may be deposited on the contacts (102, 103), which may reduce the dielectric strength of the switchgear 100. By directing the high-pressure gases towards this region, the contaminated gases may be expelled away from the first and second contacts (102, 103) thereby reducing contamination of the first and second contacts (102, 103). By more accurately aligning the second end 110g with the first gap G1, contamination of the first and second contacts (102, 103) may be further reduced.

While the illustrated configuration of the channel 110 is provided to optimise the time taken to extinguish the arc and improve the backflow of gases out of the pre-chamber area 108, the configuration of the channel 110 is not limited thereto, and the first and second ends (110a, 110g) of the channel 110 may be arranged at any alternative suitable positions of the arc guiding plate 109.

In some specific examples, the channel 110 comprises a first, second, and third straight portion (110b, 110d, 110f) and a first and second curved portion (110c, 110e). The first curved portion 110c connects the first and second straight portions (110b, 110d) and the second curved portion 110e connects the second and third straight portions (110d, 110f). This arrangement increases the effective length of the channel 110 and thereby may improve the backflow of gases out of the pre-chamber area 108.

The simple structure of the channel 110 provided may also simplify the manufacturing process of the arc guiding plate 109. The illustrated configuration is provided according to a preferred example; however, it will be understood that the channel 110 may comprise more or less of both straight and curved portions. Alternatively, the channel 110 may be formed as an arc, or with any other suitable shape and size. The configuration of the channel 110 may be selected depending on a particular application for the plate.

The first arc runner 104 does not overlap the channel 110 when the switchgear 100 is viewed in a direction (d) perpendicular to the first surface 109a of the arc guiding plate 109. The second arc runner 105 also does not overlap the channel 110 when viewed in this perpendicular direction to the first surface 109a of the arc guiding plate 109. In FIG. 1, the direction d is into/out of the page. This arrangement may prevent or reduce obstruction of the high-pressure gases flowing into the channel 110. As such, the backflow of gases out of the pre-chamber area 108 may be further improved and thus the time taken for the arc to reach the arc extinguishing chamber 107 may be reduced.

The arc guiding plate 109 comprises a third edge 111c facing towards the second arc runner 105. The channel 110 does not meet the third edge 111c of the arc guiding plate 109. This arrangement may concentrate the backflow of gases along the channel 110 towards the first gap G1 between the first and second contacts (102, 103), helping to reduce contamination of the first and second contacts (102, 103).

The switchgear 100 comprises a second gap G2 formed between a portion of the third edge 111c of the arc guiding plate 109 and the second arc runner 105 when the switchgear 100 is viewed in the direction (d) perpendicular to the first surface 109a of the arc guiding plate 109. This gap may provide an additional outlet for the high-pressure gases in the pre-chamber area 108. This may further improve the backflow of gases out of the pre-chamber area 108. By directing the backflow of gases towards the gap alongside the second arc runner 105, any contaminated gases in the region of second arc runner 105 may also be displaced, as discussed above. This may further reduce contamination of the pre-chamber area. In other examples, there is no gap G2 (e.g. the second arc runner and the plate may be aligned or overlapping).

In some examples, the third edge 111c of the arc guiding plate 109 comprises a tapered portion 112. The tapered portion 112 extends from the intersection of the first and third edges (111a, 111c) of the arc guiding plate 109 to part way along the third edge 111c. The tapered portion 112 may act as an additional channel for the high-pressure gases to flow along, thereby further preventing the high-pressure gases from slowing down the arc or reducing this effect. In other words, this arrangement can improve the backflow of gases out of the pre-chamber area 108, thereby reducing contamination of the pre-chamber area 108. While only one tapered portion 112 is shown in the illustrated embodiment, the arc guiding plate 109 may comprise additional tapered portions to accommodate the arc runners, as required for a given application/use case.

The second arc runner 105 is partially disposed on the tapered portion 112. As the tapered portion 112 may act as an additional channel, the high-pressure gases generated by the arc may be routed away from the second arc base point. This arrangement may further prevent or reduce slowing down of arc by the high-pressure gases. This configuration may be particularly advantageous when the second arc runner 105 is longer than the first arc runner 104, as the arc base point on the second arc runner 105 may be less strongly hindered in its movement and the arc base points may reach the arc extinguishing chamber 107 at a similar time; as such, the voltage of the arc may increase quickly, and the arc may be extinguished faster.

The first and second surfaces of the arc guiding plate (109a, 109b) may comprise one or more through holes 113. In the illustrated embodiment, the first and second surfaces arc guiding plate comprise a plurality of through holes 113. One or more of the through holes 113 may be used to fasten the arc guiding plate 109 to the housing 101, for example, by fastening a screw/bolt/fastening means through the through hole 113. This may increase the stability of the arc guiding plate 109 within the housing 101. However, it will be understood that an alternative means may be used to secure the position of the arc guiding plate 109 in the switchgear 100, for example, the use of an adhesive/bond/joining means.

One or more of the through holes 113 may be used to ventilate the high-pressure gases within the pre-chamber area 108 towards other regions of the switchgear 100. This arrangement may further prevent the high-pressure gases in the pre-chamber area 108 from slowing the arc down on its way to the arc extinguishing chamber 107 or reduce this effect. This arrangement may also reduce the pressure in, and improve the backflow of gases out of, the pre-chamber area 108. By directing the backflow of gases towards other regions of the switchgear 100, the backflow of gases may displace the hot, contaminated, gases towards other regions of the switchgear 100 and ultimately out of the switchgear, thereby reducing contamination throughout the switchgear 100 around the contacts and within the switchgear housing.

In the illustrated embodiment, the plurality of through holes 113 are formed proximate to the first arc runner 104. This arrangement may further prevent or reduce the arc being slowed down by the high-pressure gases generated in the region of the first arc base point, as the high-pressure gases may be ventilated out of the pre-chamber area 108 through the through holes 113 and away from the base/foot point of the arc. However, the through holes 113 are not limited to this arrangement.

The arc guiding plate 109 is made of an insulating (non-conductive) material. A material may be considered insulating (non-conductive) if it has a conductivity of less than 10⁻¹⁰ (Ω·m)⁻¹. In some embodiments, the arc guiding plate 109 may be made of a ceramic or a plastic material. A plastic material is a material comprising polymers as a main component. The specific properties of a polymer, such as its durability, fire resistance, and heat conductivity, depend on its structure; in some embodiments, a polymer with a relatively high Comparative Tracking Index (CTI), which is used to measure the electrical breakdown properties of an insulating material, may be used for the arc guiding plate 109. Examples of polymers with a high CTI include materials such as polyamide or poly butylene terephthalate. However, the arc guiding plate 109 is not limited thereto, and any suitable non-conductive or insulating material, including any suitable ceramic or plastic, may be used.

This configuration may be used in electric circuits with lower nominal currents, for example, currents less than 40 A. However, this material may also be suitable for electric circuits with nominal currents higher than 40 A. This choice of material may also reduce the cost of manufacturing the arc guiding plate 109. However, other materials may be used which are suitable for different nominal currents of the electric circuit for which the switchgear 100 is provided. Moreover, the use of plastic can help reduce the arc energy. For example, a small fraction of the plastic material could vaporize, reducing the arc energy (cooling) by the evaporation energy of the plastic material.

The arc guiding plate 109 described may be a first arc guiding plate 109 and the switchgear 100 may further comprise a second arc guiding plate 119. The first arc runner 104 and the second arc runner 105 may be at least partially disposed between the first arc guiding plate 109 and the second arc guiding plate 119 to form the pre-chamber area 108. By forming the pre-chamber area 108 with a first and second arc guiding plate (109, 119) comprising the aforementioned advantageous features, the backflow of gases out of the pre-chamber area 108 may be improved, helping move the arc towards the arc extinguishing chamber.

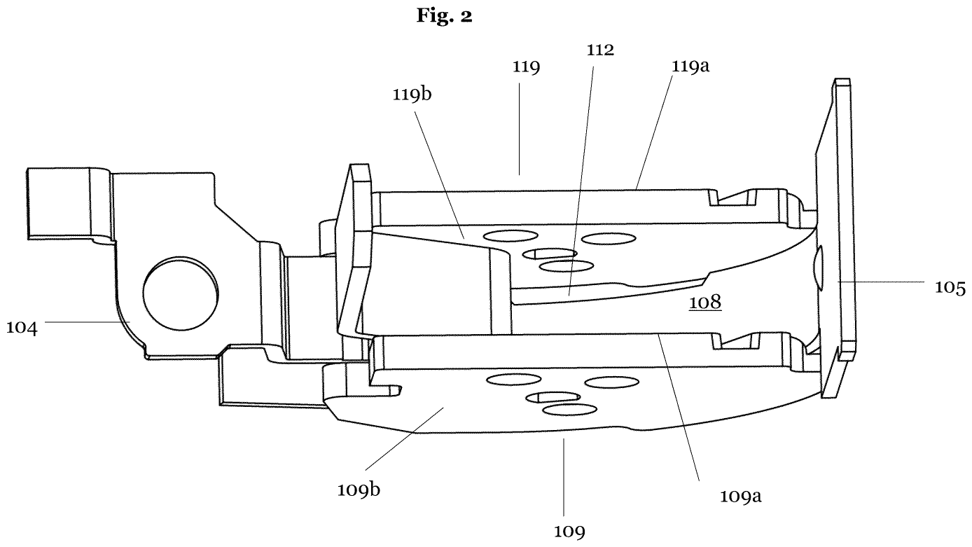

FIG. 2 illustrates the pre-chamber area 108 of the switchgear 100 according to a first example. The first arc runner 104 and the second arc runner 105 are partially disposed between a first arc guiding plate 109 and a second arc guiding plate 119. The first and second arc guiding plates (109, 119) are identical. The pre-chamber area 108 is formed by the first arc runner 104, the second arc runner 105, the first surface of the first arc guiding plate 109a and the second surface of the second arc guiding plate 119b. This asymmetrical configuration is advantageous, as first and second arc guiding plates can be manufactured using the same mould. This may reduce the time and cost of manufacturing the pre-chamber area.

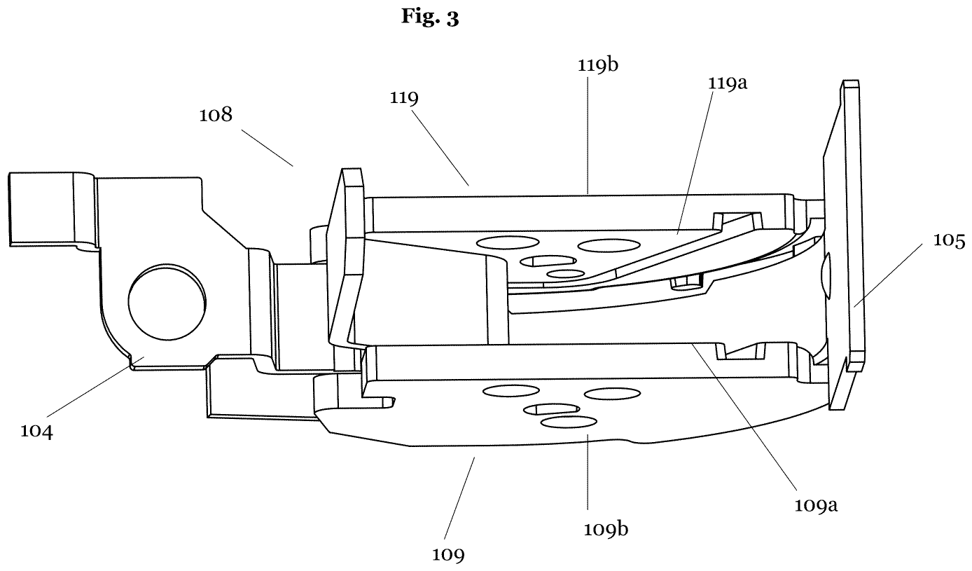

FIG. 3 illustrates the pre-chamber area 108 of the switchgear 100 according to a second example. The first arc runner 104 and the second arc runner 105 are partially disposed between a first arc guiding plate 109 and a second arc guiding plate 119. The first and second arc guiding plates (109, 119) are symmetric to each other. The pre-chamber area 108 is formed by the first arc runner 104, the second arc runner 105, the first surface of the first arc guiding plate 109a and the first surface of the second arc guiding plate 119a. By forming the first and second arc guiding plates to be symmetric, the pre-chamber area 108 comprises two open channels. This may increase the arc extinguishing capacity of the switchgear 100. This arrangement may be particularly advantageous for switchgear 100s implemented in circuits with relatively high nominal currents.

Alternatively, the pre-chamber area 108 may be formed by the first arc runner 104 and the second arc runner 105 partially disposed between an arc guiding plate 109 of the first embodiment and another plate with an alternative configuration, for example a flat plate.

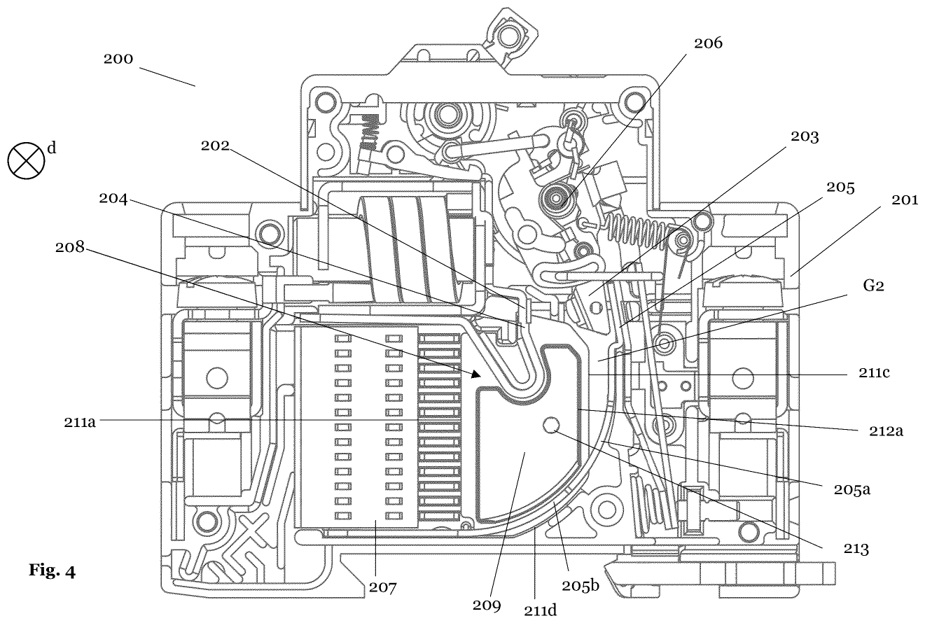

With reference to FIGS. 4 to 6, a switchgear 200 comprising a second embodiment of an arc guiding plate 209 for protecting an electrical circuit is described.

The individual components of the switchgear 200 described herein may be enclosed in a housing 201. The switchgear 200 comprises a first contact 202 and a second contact 203 which are electrically connected to an electrical circuit. The first and second contacts (202, 203) form an electrical conducting path through the switchgear 200. The first contact 202 is arranged such that it is stationary within the housing 201. The second contact 203 is arranged such that it can be moved relative to the first contact 202 within the housing 201. The second contact 203 is configured to be moved such that it is either electrically connected to the first contact 202 and enables current to flow, or is separated from the first contact 202 and interrupts the flow of current.

The switchgear 200 comprises an actuating element 206 connected to the second contact 203. The actuating element 206 is, in these specific examples, configured together with an electromechanical relay device to move the second contact 203, such that it is separated from the first contact 202 when a higher than “normal” current flows through the electrical circuit (that is, a current higher than a maximum current for which the switchgear was designed and tested to work reliably). It will be understood that any suitable actuating element may be used.

When the first and second contacts (202, 203) are separated due to a high current in the electrical circuit, an arc is formed between the first and second contacts (202, 203). A first and second arc base point is formed on the first and second contacts (202, 203), respectively, and the air is ionised so that it becomes electrically conducting; the arc is formed in the air between the first and second contacts (202, 203).

The switchgear 200 further comprises a first arc runner 204 and a second arc runner 205, which are electrically connected to the first and second contacts (202, 203), respectively. The first arc runner 204 has a shorter length than the second arc runner 205. As such, the second arc base point takes a longer time to reach the arc extinguishing chamber 207 than the first arc base point (because the second arc runner 205 is longer). However, the first and second arc runners (204, 205) may have the same length, or the first arc runner 204 may have a longer length than the second arc runner 205.

The first and second arc runners (204, 205) extend between the first and second contacts (202, 203), respectively, and an arc extinguishing chamber 207. Magnetic forces (Lorentz force) created by the high current act on the arc and drive the arc away from the separated first and second contacts (202, 203) and along the first and second arc runners (204, 205) towards an arc extinguishing chamber 207.

The arc extinguishing chamber 207 is a device configured to extinguish the arc when it enters the arc extinguishing chamber 207. In the illustrated embodiment, the arc extinguishing chamber 207 comprises a plurality of conducting rods/plates arranged parallel to and spaced apart from each other, as discussed above. When the arc strikes the conducting rods/plates, it is divided into a corresponding plurality of partial arcs or sub-arcs which are electrically connected in series. In other words, additional arc base points are created on all of the conducting rods within the arc extinguishing chamber 207. In this way, the arc voltage is increased such that the current is insufficient to maintain the arc and the arc is extinguished. However, alternative arc extinguishing chambers which employ a different mechanism to extinguish the arc, which are well known in the state of the art, may be used instead of or as well as. In other words, any suitable arc extinguishing approach may be used.

The switchgear 200 further comprises an arc guiding plate 209 disposed in a region in front of the arc extinguishing chamber 207. The arc guiding plate 209 comprises a first surface 209a and a second surface 209b opposite to the first surface 209a. The shape of the arc guiding plate 209 is configured to generally extend between the first and second contacts (202, 203) and the arc extinguishing chamber 207. The first surface of the arc guiding plate 209a, the first arc runner 204 and the second arc runner 205 at least partially define a pre-chamber area 208. The first arc runner 204 is at least partially disposed on the first surface of the arc guiding plate 209a; in this example, the first arc runner is fully disposed on the first surface of the arc guiding plate 209a.

The arc guiding plate 209 comprises a first edge 211c facing towards a first portion of the second arc runner 205a. The first edge and the first portion are not parallel to one another. For example, the first edge 211c and the first portion 205a may extend in different, divergent, directions from one another. The second arc runner 205 is therefore only partially disposed on the first surface of the arc guiding plate 209a. In particular, the first portion of the second arc runner 205a is disposed outside of the region in which the arc guiding plate 209 is disposed. In other words, when viewed in a direction (d) perpendicular to the first surface of the plate 209, the first portion does not overlap the plate. There may be a gap G2 between the first edge of the arc guiding plate 211c and the first portion 205a of the second arc runner 205 when the switchgear 200 is viewed perpendicular to the first surface of the arc guiding plate 209a. This gap G2 may provide an additional outlet for the high-pressure gases within pre-chamber area 208 and thereby improve the backflow of gases out of pre-chamber area 208.

In the specific examples shown herein, the first edge 211c is a straight edge 211c. The straight edge can extend in a generally vertical direction, when in use in the switchgear. The high-pressure gases can vent in the space or gap between the straight edge of the arc guiding plate 211c and the first portion 205a of the second arc runner 205. This may reduce the exposure of the second arc base point to the retarding effect of high-pressure gases in the pre-chamber area 208 and thereby reduce the slowing down of the second arc base point. As such, the first and second arc base points may arrive at the arc extinguishing chamber 207 closer together in time. The voltage of the arc may thereby increase faster, and the arc may be extinguished faster. A switchgear 200 with improved arc extinguishing ability may therefore be provided.

Additionally, the straight edge 211c reduces the surface area of the arc guiding plate 209 such that it does not fill the region between the first and second contacts (202, 203), first and second arc runners (204, 205), and the arc extinguishing chamber 207. In this way, the total surface area of the arc guiding plate 209 may be reduced in comparison to previous arc guiding plates. In particular, the arc guiding plate 209 according to a second embodiment of the disclosure has a reduced surface area in comparison to the arc guiding plate 109 according to a first embodiment of the disclosure. The reduced surface area of the arc guiding plate 209 may reduce the pressure in the pre-chamber area 208 by reducing the wall surface area of the pre-chamber area 208, and providing efficient venting of the high-pressure gases generated in front of and behind the arc. This arrangement may prevent or reduce the high-pressure gases from slowing down the arc and reduce contamination of the pre-chamber area 208.

The straight edge of the arc guiding plate 211c may be a first straight edge and the arc guiding plate 209 may further comprise a second straight edge 211a facing towards the arc extinguishing chamber 207. In some embodiments, the arc guiding plate 209 may comprise additional straight edges. The first straight edge 211c and the second straight edge 211a may be parallel to each other. This configuration may simplify manufacturing and improve alignment of the plate with the chamber.

The first and second surfaces of the arc guiding plate (209a, 209b) may not comprise any grooves or channels. In other words, no grooves or channels may be formed on the first and second surfaces of the arc guiding plate (209a, 209b). Forming a channel on the first surface or second surface of the arc guiding plate (209a, 209b) creates a relatively thin region/area of the arc guiding plate 209 compared to a thickness of the rest of the arc guiding plate 209, which thinner area may not be able to withstand the high-pressures which occur in the pre-chamber area 208 as well as the thicker regions of the plate 209.

By not forming any grooves or channels on the first and second surfaces of the arc guiding plate, the robustness of the arc guiding plate 209 may be improved. The plate may therefore be used for higher load applications, with higher energy arcs than the plate of the first embodiment. The manufacturing process of the arc guiding plate 209 may also be simplified in this way. However, the first and second surfaces of the arc guiding plate are not limited thereto.

The first surface of the arc guiding plate 209a comprises a central protrusion 212a. The central protrusion 212a may increase the thickness of at least a portion of the arc guiding plate 209 such that the robustness of the arc guiding plate 209 may be further improved. The first and second arc runner (204, 205) may not overlap the central protrusion 212a on the first surface of the arc guiding plate 209a when the switchgear 200 is viewed perpendicular to the first surface of the arc guiding plate 209a. This allows a robust plate to be provided within a relatively compact footprint.

The second arc runner 205 comprises a second portion 205b disposed between the first portion 205a of the second arc runner 205 and the arc extinguishing chamber 207. The second portion 205b may be disposed on the first surface of the arc guiding plate 209a between the central protrusion 212a and a curved edge 211d of the arc guiding plate. However, the second portion 205b may be disposed on the curved edge 211d of the arc guiding plate or outside of the arc guiding plate 209. The curved edge 211d of the arc guiding plate may guide backflow of gases through the pre-chamber area such that stagnation pressure in this area of the plate is reduced.

The region between the central protrusion 212a and the second portion of the second arc runner 205b may act as a channel. This channel like region may route high pressure gases generated by the arc and the backflow of gases out of the pre-chamber area 208. In this way, the second arc base point may not be slowed down by the high-pressure gases as it moves towards the arc extinguishing chamber 207. This may further improve the timed entry behaviour of the first and second arc base points into the arc extinguishing chamber 207. This configuration is advantageous as an effective channel may be formed on the first surface of the arc guiding plate 209a, without reducing the robustness of the arc guiding plate 209 in the process. This effective channel may also improve the backflow of gases reflected by the arc extinguishing chamber 207 out of the pre-chamber area 208, reducing contamination once the arc is extinguished.

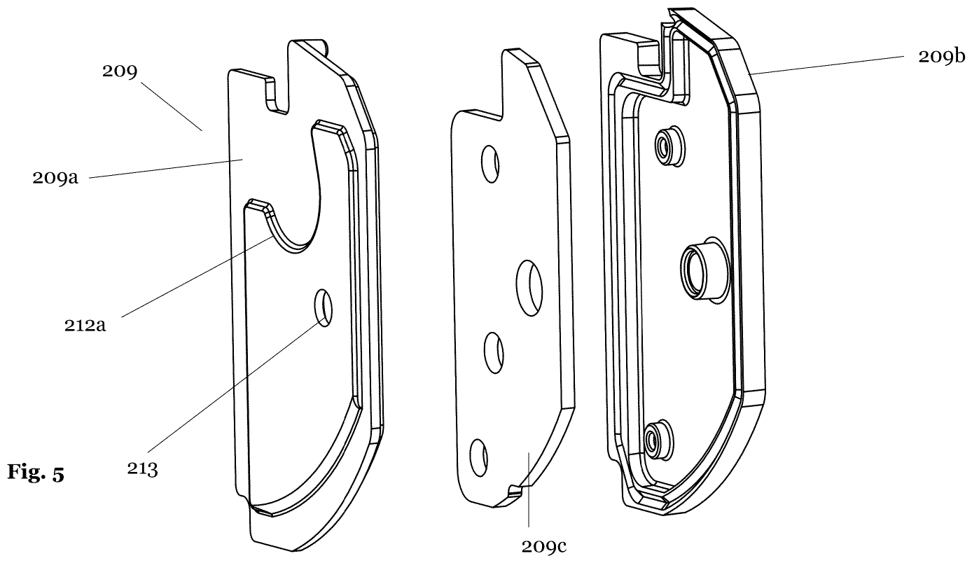

FIG. 5 illustrates the assembly of the arc guiding plate 209 according to an example of the second embodiment.

The first surface of the arc guiding plate 209a and the second surface of the arc guiding plate 209b may be formed as separate pieces and assembled into an integrated structure. This configuration may improve the robustness of the plate. The first and second surfaces may be assembled into an integrated structure using any suitable means, for example, ultrasonic welding, applying an adhesive, etc.

The first and second surface of the arc guiding plate (209a, 209b) may be made of an insulating material. The use of an insulating material my reduce the risk of electrical and thermal damage caused by the electric arc. The insulating material may be a plastic material. The use of a plastic, or other dedicate plate material could also support to de-energize the arc, as a small fraction of the plastic material could vaporize, reducing the arc energy (cooling) by the evaporation energy of the plastic material.

A metal plate 209c may be disposed between the first and second surface (209a, 209b) of the arc guiding plate 209. This may improve the arc extinguishing capacity of the arc guiding plate 209 by amplifying the magnetic forces (Lorentz force) driving the arc towards the (arc extinguishing) chamber 207. The first and second surface of the arc guiding plate (209a, 209b) may be configured to completely surround the metal plate 209c. This may insulate the metal plate 209c from the electric arc, and improve the robustness of the arc guiding plate 209. This arrangement may be particularly advantageous for currents with relatively high nominal currents, e.g., for circuit breakers.

The central protrusion of the first surface 209a of the arc guiding plate 209 may be a first central protrusion 212a. The second surface 209b of the arc guiding plate may comprise a second central protrusion 212b. The second central protrusion 212b may be configured to be symmetric to the first central protrusion 212a. By having a first and second central protrusion, the thickness and thereby the robustness of the arc guiding plate 209 may be improved, without increasing the overall footprint. Alternatively, the second surface of the arc guiding plate 209b may be flat (may comprise no protrusions). This may simplify the manufacturing process of the arc guiding plate 209 as only one mould is required to form the first surface of the arc guiding plate 209a.

The metal plate 209c is shaped to facilitate the formation of electromagnetic forces in a direction towards the arc extinguishing chamber. This may prevent or reduce the slowing down of second arc base point by the arc guiding plate 209 by shaping the direction and amplification of the magnetic forces to drive the arc along the second arc base point towards the arc extinguishing chamber. This may improve the timed-entry behaviour of arc base points into the arc extinguishing chamber 207 and thereby the arc may be extinguished more quickly.

The first and second surface of the arc guiding plate (209a, 209b) and the metal plate 209c may each comprise at least one through hole. The at least one the through hole of each of the first and second surface of the arc guiding plate and the metal plate may be aligned. In the illustrated example, each of the first and second surface of the arc guiding plate 209 and the metal plate comprise one through hole 213. The at least one through hole 213 may provide a means of fastening the arc guiding plate 209 into a position within the switchgear. In this way, the stability of the arc guiding plate 209 may be improved. However, it will be understood that the position of the arc guiding plate 209 within the switchgear 200 may be secured using any alternative suitable means, for example the use of an adhesive.

The first arc runner 204 may at least partially overlap the metal plate 209c of the arc guiding plate 209 when the switchgear 200 is viewed in a direction (d) perpendicular to the first surface of the arc guiding plate 209a. It will be understood that the term “overlap” means that a first component is disposed directly onto a second component or that there are additional components disposed in between the first and second component. In this context, the first arc runner 204 partially overlaps the metal plate 209c and the first surface of the arc guiding plate 209a is disposed in between. This arrangement may slow down the first arc base point as it travels towards the arc extinguishing chamber 207 as retarding effects of the magnetic forces on the first arc base point are amplified. This arrangement may also increase the exposure of the first arc base point to the high-pressure gases in the pre-chamber area, which may also slow down the first arc base point. This may improve the timed entry behaviour of the arc into the arc extinguishing chamber 207.

The switchgear 200 may comprise a flat plate configured to extend between the first and second contacts (202, 203) and the arc extinguishing chamber 207. The first and second arc runners (204, 205) may be at least partially disposed between the first surface of the arc guiding plate 209a and the flat plate. The pre-chamber area 208 may be defined by the first arc runner 204, the second arc runner 205, the arc guiding plate 209 and the flat plate.

Alternatively, the arc guiding plate 209 may be a first arc guiding plate 209 and the switchgear 200 may further comprise a second arc guiding plate (not shown). The first arc runner 204 and the second arc runner 205 may be at least partially disposed between the first surface 209a of the first arc guiding plate 209 and the second surface of the second arc guiding plate to form the pre-chamber area 208.

With reference to FIG. 4, the pre-chamber area 208 of the switchgear 200 according to an example can be formed using an arc guiding plate in accordance with FIG. 5, in which the first and second surfaces of the arc guiding plate (209a, 209b) comprise a first central protrusion 212a and a second central protrusion (not shown), respectively. The first and second central protrusions are symmetric. The arc guiding plate 209 is a first arc guiding plate 209 and the switchgear 200 comprises a second arc guiding plate (not shown) configured to be identical to the first arc guiding plate 209. The first and second surfaces of the second arc guiding plate also comprise a first central protrusion and a second central protrusion, respectively. The first and second central protrusions are symmetric. The pre-chamber area 208 is thus defined by the first and second arc runners (204, 205), the first surface of the first arc guiding plate 209a and the second surface of the second arc guiding plate. In this way, the robustness, the arc extinguishing capacity, and the backflow of gases out of the pre-chamber area 208 may be further improved.

This arrangement may be particularly advantageous for switchgears implemented in circuits with relatively high nominal currents.

Also disclosed is:
Example 1. A switchgear comprising: a first contact and a second contact configured to form an electrical conducting path through the switchgear, wherein the second contact can be moved relative to the first contact; a first arc runner electrically connected to the first contact; a second arc runner electrically connected to the second contact when the first contact and the second contact are in a separated state; an arc extinguishing chamber arranged at least partially in a space between the first arc runner and the second arc runner; an arc guiding plate having a first surface and a second surface opposite to the first surface, wherein the arc guiding plate comprises a first edge facing towards a first portion of the second arc runner, wherein the first edge and the first portion are not parallel to one another; a pre-chamber area disposed between the arc extinguishing chamber and the first and second contacts, wherein the pre-chamber area is at least partially defined by the first and second arc runners and the first surface of the arc guiding plate; wherein the first arc runner and the second arc runner are at least partially disposed on the first surface of the arc guiding plate; and wherein the first arc runner has a shorter length than the second arc runner.
Example 2. The switchgear according to example 1, wherein the first edge is a straight edge. Optionally, there is a gap between the straight edge of the arc guiding plate and the first portion of the second arc runner when the switchgear is viewed perpendicular to the first surface of the arc guiding plate.
Example 3. The switchgear according to example 2, wherein the straight edge of the arc guiding plate is a first straight edge and the arc guiding plate further comprises a second straight edge facing towards the arc extinguishing chamber.
Example 4. The switchgear according to example 3, wherein the first straight edge and the second straight edge are parallel to each other.
Example 5. The switchgear according to any one of the preceding examples, wherein the first and second surfaces of the arc guiding plate do not comprise any grooves or channels.
Example 6. The switchgear according to any of the preceding examples, wherein the first surface of the arc guiding plate and the second surface of the arc guiding plate are formed as separate pieces and assembled into an integrated structure.
Example 7. The switchgear according to example 6, wherein the first and second surface of the arc guiding plate are made of an insulating material (optionally a plastic material) and wherein a metal plate is disposed between the first and second surface of the arc guiding plate, wherein the first and second surface of the arc guiding plate are configured to completely surround the metal plate.
Example 8. The switchgear according to example 7, wherein the metal plate is configured such that the distance/radius between the metal plate and the second arc runner is larger than distance/radius between the metal plate and the first arc runner.
Example 9. The switchgear according to example 7 or 8, wherein the first arc runner at least partially overlaps the metal plate when the switchgear is viewed perpendicular to the first surface of the arc guiding plate.
Example 10. The switchgear according to any of the preceding examples, wherein the first surface of the arc guiding plate comprises a central protrusion.
Example 11. The switchgear according to example 10, wherein the second surface of the arc guiding plate comprises a central protrusion such that the first surface and the second surface of the arc guiding plate are symmetric.
Example 12. The switchgear according to example 11, wherein the second surface of the arc guiding plate is flat.
Example 13. The switchgear according to any of example 10 to 12, wherein the first and second arc runner do not overlap the central protrusion on the first surface of the arc guiding plate when the switchgear is viewed perpendicular to the first surface of the arc guiding plate.
Example 14. The switchgear according to example 13, wherein a second portion of the second arc runner is disposed on the first surface of the arc guiding plate between the central protrusion and a curved edge of the arc guiding plate.
Example 15. The switchgear of example 13, wherein the second portion of the second arc runner is disposed between the first position of the second arc runner and the arc extinguishing chamber.
Example 16. The switchgear according to any of the preceding examples, wherein the first and second surface of the arc guiding plate and the metal plate each comprise at least one through hole and wherein the at least one through holes are aligned.
Example 17. The switchgear according to any of the preceding examples, wherein the arc guiding plate is a first arc guiding plate and the switchgear further comprises a second arc guiding plate, and wherein the first arc runner and the second arc runner are at least partially disposed between the first arc guiding plate and the second arc guiding plate to form the pre-chamber area.

1. A switchgear comprising:
a first contact and a second contact configured to form an electrical conducting path through the switchgear, wherein the second contact can be moved relative to the first contact;
a first arc runner electrically connected to the first contact;
a second arc runner electrically connected to the second contact when the first contact and the second contact are separated;
an arc extinguishing chamber arranged at least partially in a space between the first arc runner and the second arc runner;
an arc guiding plate having a first surface and a second surface opposite to the first surface, wherein the arc guiding plate is formed in a single piece from a non-conductive material;
a pre-chamber area disposed between the arc extinguishing chamber and the first and second contacts, wherein the pre-chamber area is at least partially defined by the first and second arc runners and the first surface of the arc guiding plate;
wherein the first arc runner and the second arc runner are at least partially disposed on the first surface of the arc guiding plate;
wherein the first surface of the arc guiding plate comprises a channel having a first end and a second end wherein the first and second ends of the channel are open.

2. The switchgear according to claim 1, wherein the second surface of the arc guiding plate does not comprise a channel, optionally wherein the second surface of the arc guiding plate is flat.

3. The switchgear according to claim 1, wherein the arc guiding plate comprises a first edge facing towards the arc extinguishing chamber and the first end of the channel meets the first edge of the arc guiding plate.

4. The switchgear according to claim 1, wherein the arc guiding plate comprises a second edge facing towards a region of the switchgear in which the first and second contacts are at least partially disposed, and the second end of the channel meets the second edge of the arc guiding plate.

5. The switchgear according to claim 4, wherein a position at which the second end of the channel meets the second edge of the arc guiding plate is aligned with a first gap formed between the first and second contacts when the first and second contacts are separated.

6. The switchgear according to claim 1, wherein the channel comprises a first, second, and third straight portion and a first and second curved portion and wherein the first curved portion connects the first and second straight portions and the second curved portion connects the second and third straight portions.

7. The switchgear according to claim 1, wherein the first arc runner does not overlap the channel when the switchgear is viewed in a direction perpendicular to the first surface of the arc guiding plate.

8. The switchgear according to claim 1, wherein the arc guiding plate comprises a third edge facing towards the second arc runner and the channel does not meet the third edge of the arc guiding plate.

9. The switchgear according to claim 8, wherein there is a second gap between at least a portion of the third edge of the arc guiding plate and the second arc runner when the switchgear is viewed in a direction perpendicular to the first surface of the arc guiding plate.

10. The switchgear according to claim 8, wherein the third edge of the arc guiding plate comprises a tapered portion.

11. The switchgear according to claim 10, wherein the second arc runner is at least partially disposed on the tapered portion of the third edge of the arc guiding plate.

12. The switchgear according to claim 1, wherein the first and second surfaces of the arc guiding plate comprises one or more through holes.

13. The switchgear according to claim 1, wherein the arc guiding plate is made of a plastic material.

14. The switchgear according to claim 1, wherein the arc guiding plate is a first arc guiding plate and the switchgear further comprises a second arc guiding plate, and wherein the first arc runner and the second arc runner are at least partially disposed between the first arc guiding plate and the second arc guiding plate to form the pre-chamber area.

15. The switchgear according to claim 14, wherein the second arc guiding plate is identical to the first arc guiding plate, and wherein the first surface of the first arc guiding plate and the second surface of the second arc guiding plate form the pre-chamber area.

16. An arc guiding plate, formed in a single piece from a non-conductive material, the plate comprising:
a first surface, and
a second surface opposite to the first surface, wherein the first surface of the plate comprises a channel having a first end and a second end, and the first and second ends of the channel are open.
